(19) United States
(12) Patent Application Publication
(10) Pub. No.: US 2003/0069894 A1
(43) Pub. Date: Apr. 10, 2003

(54) Computer-based system for assessing compliance with governmental regulations

(76) Inventors: Darlene Cotter, Ingleside, IL (US); Anne M. De Franco, Vernon Hills, IL (US); Marilyn E. Haydam, Johnsburg, IL (US); John D. Hinders, Dublin, OH (US); Mark J. Janaes, Libertyville, IL (US); Gina M. Jans, Waukegan, IL (US); Craig McGill, Gurnee, IL (US); Laura E. Obenauf, Lake Forest, IL (US); Jon Ogle, Lindenhurst, IL (US); Russell Reder, Glenview, IL (US); Robert Steinmeier, Long Grove, IL (US); Deborah J. Zuccollo, Buffalo Grove, IL (US)

Correspondence Address: STEVEN F. WEINSTOCK, ABBOTT LABORATORIES, 100 ABBOTT PARK ROAD, DEPT. 377/AP6A, ABBOTT PARK, IL, 60064-6008, US

(21) Appl. No.: 09/954,103

(22) Filed: Sep. 17, 2001

(51) Int. Cl. G06F 7/00

(52) U.S. Cl. 707/104.1

(57) ABSTRACT

A computer-based system comprising the following three components:

(1) an electronic database that documents a governmental regulation and associates the regulation with a firm's interpretations and best practices for compliance therewith;

(2) an electronic database that records descriptive information relating to a computer-based system and screening criteria to determine if the computer-based system being inventoried is covered by the governmental regulation; and

(3) an electronic database that assesses whether the computer-based systems included in the inventory and covered by the regulation meet the criteria of compliance.

Preferably, the computer-based system further comprises means for tracking actions taken to correct any deficiencies noted.

This invention provides numerous benefits. One major benefit involves providing the capability to determine whether the computer-based systems of a firm comply with a governmental regulation. A second major benefit involves providing a means for remediating the computer-based system, if the assessment of the computer-based system indicates that the computer-based system does not meet the criteria of compliance. A third major benefit involves providing a means for tracking the status of any projects for remediating those computer-based systems that fail to comply with the regulation.

### BACKGROUND OF THE INVENTION

1. Field of the Invention

This invention relates to computer-based systems involved in all aspects of data processing in a regulated environment, including the capture, analysis, presentation, and storage of data. This invention relates to the use of computer-based systems for evaluating computer-based systems for compliance with governmental regulations.

2. Discussion of the Art

The United States Food and Drug Administration (FDA) regulates research, product development, manufacturing, and documentation of distribution and other processes in the areas of pharmaceutical and medical devices to ensure the safety and efficacy of certain products used in human health care. The recording, processing, reporting, and approval of data and other information related to the foregoing regulatory activity is rapidly evolving from manual, paper-based systems to computer-based systems. In August of 1997, the FDA enacted regulations (21 CFR Part 11) that describe requirements for allowing electronic records and signatures to be the equivalent of the paper documents that were previously used. In view of these regulations, computer-based systems in existence prior to August of 1997, as well as any new computer-based systems put into operation after that date, must be assessed to determine whether they comply with the regulations. If the computer-based systems are determined to be deficient, remedies must be implemented and the systems validated.

Many firms involved in the discovery, development, manufacture, and distribution of pharmaceutical products and/or medical devices have hundreds or thousands of computer-based systems and devices that are used in operations regulated by the FDA. Within a given organization, it is not uncommon to find a number of separate departments using information systems related to the discovery, development, manufacture, distribution, and tracking of products used in human health care. These departments include, but are not limited to, data processing, engineering, quality assurance, and regulatory affairs. Compliance with regulations may be even more complicated in firms having diverse product lines and widely separated manufacturing operations, logically or physically or both.

Compliance with 21 CFR Part 11 requires not only a widespread understanding of the regulation, but also requires a widespread understanding of the firm's interpretation of the regulation in order to bring about consistency across the enterprise. Compliance with 21 CFR Part 11 requires the identification of all computer-based systems, including laboratory instrumentation operated and controlled by computer-based systems, used across the enterprise so that each computer-based system can be evaluated to determine whether or not the system is subject to 21 CFR Part 11. This identification is alternatively referred to herein as an inventory. If a given computer-based system is subject to the regulation, a determination of whether or not the computer-based system complies with the regulation is further required by 21 CFR Part 11. If a computer-based system is subject to the regulation and is determined not to be compliant with the regulation, the firm must also identify the areas of non-compliance and develop a plan to bring that computer-based system into compliance with the regulation.

Those firms having relatively few computer-based systems subject to 21 CFR Part 11 may be able to identify, evaluate, and maintain records in order to comply with 21 CFR Part 11 by means of manual, paper-based systems. Firms that have hundreds or thousands of computer-based systems subject to 21 CFR Part 11 will likely find it to be impractical to depend upon manual, paper-based systems to comply with 21 CFR Part 11. Accordingly, it would be desirable to develop a computer-based system, and a method of using that system, for enabling a firm, typically a firm having a large number of computer-based systems, to comply with complex governmental regulations.

### SUMMARY OF THE INVENTION

This invention provides a computer-based system for documenting and distributing, preferably by electronic means, a firm's interpretation of a governmental regulation along with best practices, standards, and examples for implementation to achieve compliance with the regulation. The invention also provides a method for documenting and approving an inventory comprising computer-based systems and for evaluating each of the computer-based systems in the inventory to determine whether the system complies with the governmental regulation. A representative example of such a governmental regulation is 21 CFR Part 11 Electronic Record; Electronic Signature regulation of the Food and Drug Administration.

The computer-based system comprises three components. The first component comprises an electronic database that documents the governmental regulation and associates the regulation with interpretations by the firm and best practices (functional requirements) for compliance therewith. An example of this first component may be designated as the “Guide to the Regulation”, e.g., “Guide to 21 CFR Part 11”.

The second component comprises an electronic database that records descriptive information relating to a computer-based system (e.g., name, owner, purpose, etc., of the system) and screening criteria to determine if the computer-based system being inventoried is covered by the governmental regulation. An example of this component may be designated as the “Inventory Tool”.

The third component comprises an electronic database that assesses, based on pre-determined criteria, whether the computer-based systems included in the inventory and covered by the regulation meet the criteria of compliance. An example of this component may be designated as the “Evaluation Tool”.

A fourth component, which is optional, but greatly preferred, provides the ability to remediate the computer-based system, if the assessment provided by the third component indicates that the computer-based system does not meet the criteria of compliance.

The invention provides for the electronic routing of the documentation that records the descriptions of the computer-based systems, the responses to questions, and the approval of that documentation by means of an electronically applied signature. The invention also provides reports that relate in detail the status of activities relating to inventory and assessment. The invention also provides the capability to document and report parameters relating to the computer-based system (e.g., complexity of the system, effect on the health and safety of customers, etc.). These reports assist in the prioritization of remediation of defects and shortcomings that cause the system to fail to meet the governmental regulation. The invention also tracks the status of any projects required to remedy those computer-based systems that fail to comply with the regulation.

The computer-based system of this invention can be designed so that it can be controlled and operated from a central location. Alternatively, the computer-based system can be designed so that the system can be distributed to remote locations and controlled and operated in a decentralized manner.

The invention is designed to support a firm's efforts, through the use of a computer-based system, to manage and control a firm's program to meet the criteria established in a governmental regulation. An example of such a regulation is 21 CFR Part 11, which relates to the preparation, processing, and storage of electronically generated documentation.

This invention provides numerous benefits. One major benefit involves providing the analytical capability to determine whether the computer-based systems of a firm comply with a governmental regulation. A second major benefit involves providing the capability to document conclusions reached, if the assessment, i.e., evaluation, of the functional characteristics of the computer-based system, against the requirements of the regulation, indicates that the computer-based system does not meet the criteria of compliance. A third major benefit involves providing a means for tracking the status of any projects for remediating those computer-based systems that fail to comply with the regulation.

### BRIEF DESCRIPTION OF THE DRAWINGS

FIG. 1 is a schematic diagram illustrating the relationship among the components of the system. One component comprises an electronic database that documents the governmental regulation and associates the regulation with interpretations by the firm and best practices for implementing the interpretations. Another component comprises an electronic database to record descriptive information relating to a computer-based system and screening criteria to determine if the computer-based system inventoried is covered by the governmental regulation. A third component comprises an electronic database that assesses, based on pre-determined criteria, whether the computer-based systems included in the inventory and covered by the regulation meet the criteria of compliance.

FIG. 2 is a flow chart illustrating how the Inventory Tool interacts with the Evaluation Tool, beginning with the creation of an inventory record and concluding with remediation of deficiencies with respect to meeting the criteria of compliance.

### DETAILED DESCRIPTION

As used herein, the term “regulation” means a governmental order having the force of law. The term “governmental” refers to the agency or apparatus through which a governing individual or body exercises authority and performs required duties. The term “governmental” further refers to the management or administration of an organization, business, or institution. The organization, business, or institution can be a political unit, but it is not required to be so. A representative example of a regulation is 21 CFR Part 11. As used herein, the expression “21 CFR Part 11” means a regulation issued by the FDA providing criteria for acceptance by the FDA, under certain circumstances, of electronic records and electronic signatures and handwritten signatures executed to electronic records as equivalent to paper records and handwritten signatures executed on paper. The term “interpretation” means an explanation that clarifies terms in a regulation that are ambiguous and/or terms in a regulation that are capable of being misunderstood. In this context, a representative example of an interpretation is the firm's explanation of each section and provision of 21 CFR Part 11. The term “annotation” means a note that further explains how an interpretation was derived. An annotation may be provided for an interpretation when deemed necessary. An annotation is subordinate to documents relating to the interpretation. The expression “best practice” means the generally accepted best way of performing a task within the context of the firm's operating environment. The term “example” means a specific solution associated with a specific best practice. Generally, the example involves a solution that has been previously tested and implemented. The term “standard” means a product or process accepted by an industry. Generally the standard is widely deployed and associated with a specific best practice. The term “routing” means sending computerized forms over a computer-based network to those individuals who are required to approve documentation relating to the system. The term “system” means a combination of computer hardware, computer software, application, and documentation required to create and maintain an electronic record. The expression “system development” means the process of gathering requirements, defining system specifications, generating designs, verification, validation, prototyping, and releasing the system into a production environment. The expression “Functional Requirements Specification” means a document that describes, in detail, the operation of the system. Validation of the application is based on this document(s). The term “validation” means a formal, systematic approach to compiling data that demonstrates with reasonable assurance the software and/or system will consistently achieve its specified requirements and quality attributes. The expression “electronic record” means any combination of text, graphics, data, or other representation of information (e.g., audio, pictorial) in digital form that is created, modified, maintained, archived, retrieved, or distributed by an electronic system. Digital information is not considered an electronic record until it has been initially recorded to a durable medium. The expression “electronic record content” means the actual data resulting from a transaction conducted in the normal course of business. The expression “electronic record context” refers to the identification and the reason for the business transaction from which the record was created or received. The expressions “electronic signature”, “electronically applied signature”, and the like, means a compilation of computer data involving any symbol or series of symbols executed, adopted, or authorized by an individual to be the legally binding equivalent of the individual's handwritten signature. Within a system, an electronic signature is unique to an individual. The term “assessment” means evaluation of the functional characteristics of a computer-based system against the requirements of the regulation. The expression “audit trail” means a record of the tracking of the creation, modification, or deletion of an electronic record. The audit trail is a computer generated record containing old data and/or information, new data and/or information, the identity of the person making the change, the date and time of the change, and the reason for the change as required by the regulation. The expression “meta data” means data describing the structure, data elements, interrelationships, and other characteristics of stored data.

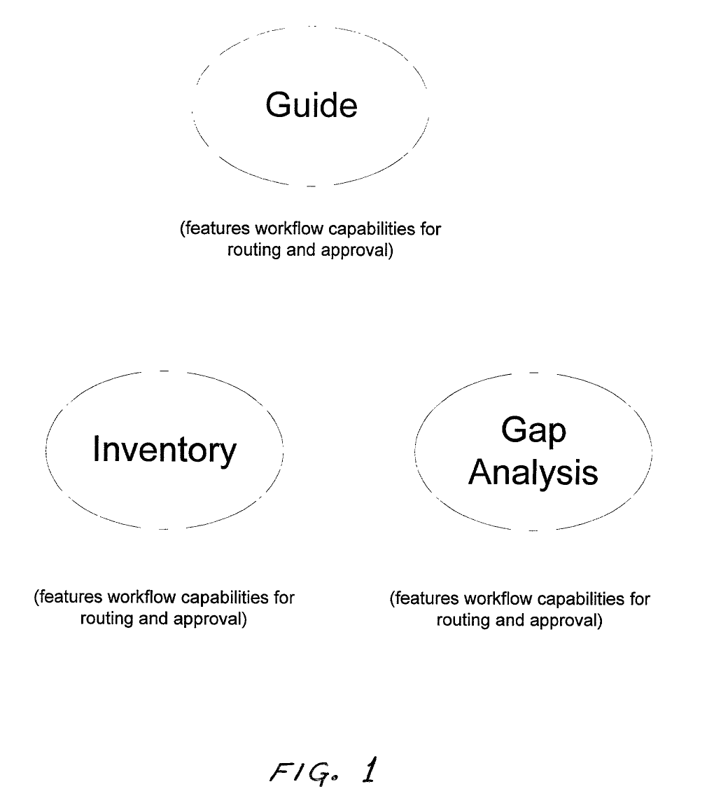

Referring now to FIG. 1, the computer-based system of this invention comprises the following three components:

(1) an electronic database that documents a governmental regulation and associates the regulation with a firm's interpretations and best practices for compliance therewith;

(2) an electronic database that records descriptive information relating to a computer-based system and screening criteria to determine if the computer-based system being inventoried is covered by the governmental regulation; and

(3) an electronic database that assesses whether the computer-based systems included in the inventory and covered by the regulation meet the criteria of compliance.

Preferably, the computer-based system further comprises means for tracking actions taken to correct any deficiencies noted.

The first component of the computer-based system of this invention comprises a database to record the text of the governmental regulation under which the computer-based system will be assessed. The first component further comprises interpretations of the text of the regulation. These interpretations may be specific to the firm on account of specificity of products or processes, characteristics of best practices for implementation of the regulation, examples of approved procedures for implementing the regulation, standards developed and approved by the firm, or any combination of the foregoing. Collectively, the interpretations, best practices, and standards are termed “qualifiers”. Another type of qualifier is an annotation. An annotation is a critical or explanatory note. The qualifiers are logically linked to the regulation. The first component of the computer-based system also contains definitions of terms that are logically linked to the regulation. These definitions can be easily accessed, as can the qualifiers described previously. Access can be achieved by designating an icon on the monitor of a personal computer that specifies the information desired. In addition, the first component provides the ability to store and display any policies and procedures of the firm that relate to compliance activities. The first component also serves as a reference guide for individuals involved in inventory, evaluation, and remediation processes. In other words, the first component can direct the individual to qualifiers, e.g., best practices and examples.

The guide to the regulation is designed to contain the following documents in a hierarchy:

Regulation—required

Interpretation—required

Annotation—optional

Best Practices—required

Examples—optional

Standards—optional

Definitions

Policies and Procedures

Of these documents, the regulation document is required. The best practices document is also required. The nature and extent of other documents linked to the regulation will be determined based on an assessment of the firm's understanding of the regulation and the need to determine consistency in implementation. The information contained in the database is organized so that a user of the system can retrieve the documents in any order.

The second component comprises an electronic database that records descriptive information relating to computer-based systems and the use thereof. This component also comprises an electronic database for describing computerized laboratory instrumentation that may be affected by the regulation. This component also comprises an electronic database for screening criteria to determine if a computer-based system contains documents subject to regulation by the government or an agency thereof and if the computer-based system itself is subject to a specific regulation of the government or agency thereof. This component also provides means for recording the results of the screening procedure in a database. This component permits the documenting and the referencing of specific questions as an aid in determining applicability of the regulation to a computer-based system. Computer-based systems that are found to be subject to the regulation will in turn be evaluated by the third component of the computer-based system.

The description of a computer-based system and conclusions reached as to the applicability of the regulation to the computer-based system must be approved by the owner of the computer-based system before the inventory entry is recorded as complete. The owner must carefully review all items describing the characteristics of the computer-based system along with answers to the questions involved in the aforementioned screening before approving the inventory record. This component enables notification via electronic mail that at least one approval signature is required. This component further enables the recording of an electronic signature by the owner to signify approval of the system or a component thereof. If the recorded item of inventory is subject to the regulation, a criticality rank is determined and documented to assist the scheduling of remediation activities should they be required. The prioritization of remediation activities can be based on such criteria as product performance, public health, or the like. After the document has been completed, an approval document is routed to a representative of the firm's quality assurance organization for approval by means of electronic signature. A representative example illustrating a more complete description of the data required for the inventory tool is contained in Table 10.

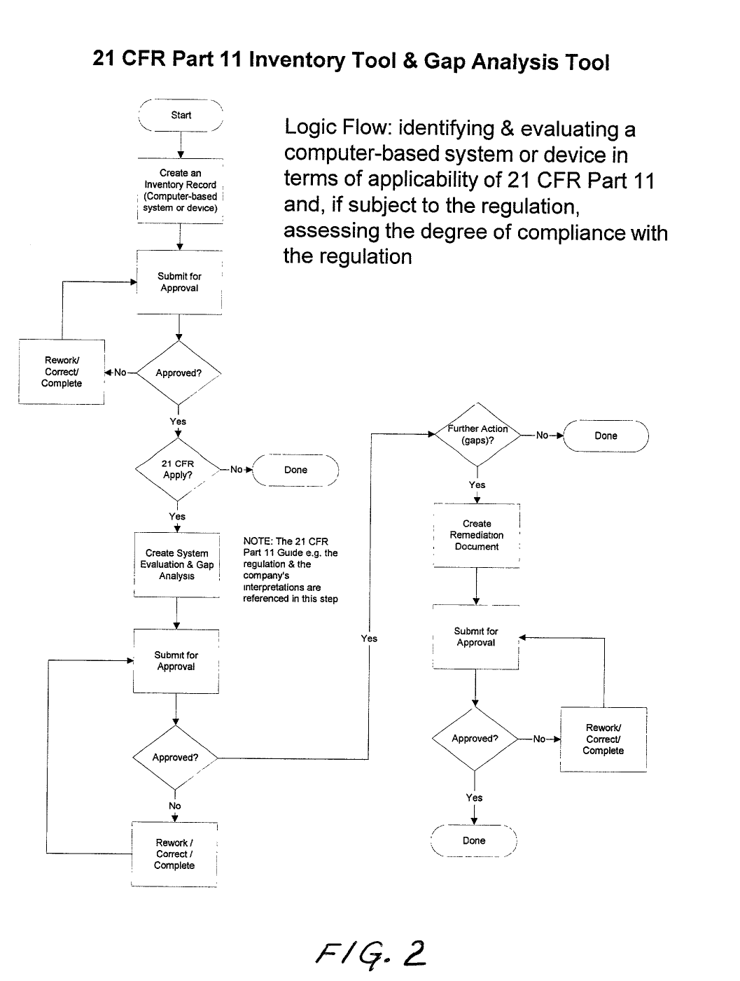

The third component of the system provides means for evaluating approved inventory items to which the regulation applies for compliance with the regulation. A series of questions derived from the interpretations contained within the guide to the regulation, e.g., Guide to 21 CFR Part 11, leads the evaluator through the evaluation process. The evaluation process includes requirements to substantiate and document conclusions reached as to whether the computer-based system in whole or in part is deemed to comply with the regulation. After the evaluation is completed, the firm's quality assurance representative assigned to the system is notified via electronic mail that the conclusions reached require approval. A representative example illustrating a more complete description of the data required for the evaluation process is contained in Tables 17, 18, and Appendix B. FIG. 2 illustrates how the Inventory Tool interacts with the Evaluation Tool, beginning with the creation of an inventory record and concluding with remediation of deficiencies with respect to meeting the criteria of compliance.

The fourth component of the system, which is optional, provides a means for tracking the status of any projects for remediating those computer-based systems that fail to comply with the regulation.

The invention can be performed with Lotus Notes groupware technology. The invention can be implemented in an environment where users have personal computers that run Microsoft Windows Operating Systems, e.g., Windows NT 3.5.1, or higher, or Windows 95, or higher, and servers that run either the Windows NT server operating systems or the Windows 2000 server operating system to host the Lotus Notes database. The supported communications protocol can be TCP/IP. The development environment can be Lotus Notes. The invention can make use of Lotus Notes technology for delivering messages. The invention is not dependent upon interfaces with other applications, but it does have the capability to incorporate links to other Lotus Notes databases or URL references in order to allow the users access to additional reference materials.

While this invention can be applied to any governmental regulation, a regulation of the federal government of the United States (i.e., 21 CFR Part 11) will be described in detail in order exemplify the invention. It should be noted that this invention can be adapted to other regulations of the United States and regulations of governmental bodies other than that of the United States.

The following functions must be employed to operate the system:

A. Creation of a document

B. Editing of a created document

C. Deleting of a document

The guide to the regulation will be a repository for the each of the sections of the regulation, e.g., 21 CFR Part 11. In the case of 21 CFR Part 11, a separate document will be created for each combination of Regulation Section (e.g., Subpart A—General Provisions) and Regulation Section Code (e.g., 11.2 (b)). The document will comprise entries generated by the system (e.g. automatic date/time notations), required entries that are generated manually, and optional entries that are generated manually (as specified in Tables 1 through 9, inclusive). Entries generated by the system are entered automatically by the computer. The fields for the Regulation document are shown in Table 1.

TABLE 1

| Functional | | | |
|---|---|---|---|
| Require- | | | |
| ment | Field | Constraint | Comment |
| 1.1 | Title | REGULATION | |
| | | COMPONENT | |
| 1.2 | Document Status | Generated | Either “Draft” or |
| | | by system | “Current” or “New” |
| 1.3 | Regulation Section | Required | Selected from list of |
| | | | choices |
| 1.4 | Regulation Section | Required | Manually entered, |
| | Code | | alphanumeric field |
| 1.5 | Regulation Title | Required | Manually entered, |
| | | | alphanumeric field |
| 1.6 | Version | Required | Manually entered, |
| | | | numeric field |
| 1.7 | Creation Date | Generated by | Date (dd-mmm- |
| | | system | yyyy) and time |
| 1.8 | Effective Date | Required | Manually entered, |
| | | | Date field (dd- |
| | | | mmm-yyyy) |
| 1.9 | Document Author | Generated by | Lotus Notes user |
| | | system | ID |
| 1.10 | Regulation Text | Required | Text field with |
| | | | spell check capabil- |
| | | | ity |
| 1.11 | Corporate Policies | Optional | Text related to |
| | | | policy documents |
| 1.12 | Responses | Generated by | The system will |
| | | system | maintain document |
| | | | links to all related |
| | | | documents in the hi- |
| | | | erarchy here |
| 1.13 | Last Updated By | Generated by | Lotus Notes user ID |
| | | system | |
| 1.14 | Last Update Date/ | Generated by | Date (dd-mmm- |
| | Time | system | yyyy) and time |

The Interpretation document will contain the firm's interpretation of each of the components of the Regulation. The fields for an Interpretation document are shown in Table 2.

TABLE 2

| Functional | | | |
|---|---|---|---|
| Require- | | | |
| ment | Field | Constraint | Comment |
| 2.1 | Title | FIRM | |
| | | INTERPRETA- | |
| | | TION | |
| 2.2 | Document Status | Generated by | Either “Draft” or |
| | | system | “Current” or “New” |
| 2.3 | Regulation Section | Inherited from the | |
| | | Regulation | |
| 2.4 | Regulation Section | Inherited from the | |
| | Code | Regulation | |
| 2.5 | Document Title | Required | Manually entered, |
| | | | alphanumeric field |
| 2.6 | Version | Required | Manually entered, |
| | | | numeric field |
| 2.7 | Creation Date | Generated by | Date (dd-mmm- |
| | | system | yyyy) and time |
| 2.8 | Effective Date | Required | Manually entered, |
| | | | date field (dd-mmm- |
| | | | yyyy) |
| 2.9 | Document Author | Generated by | Lotus Notes user ID |
| | | system | |
| 2.10 | Interpretation Text | Required | Place the text for |
| | | | this document here. |
| 2.11 | Parent Document | Generated by | The system will |
| | | system | maintain document |
| | | | links to the parent |
| | | | document here. |
| 2.12 | Responses | Generated by | The system will |
| | | system | maintain document |
| | | | links to all child |
| | | | documents here. |
| 2.13 | Last Updated By | Generated by | Lotus Notes user ID |
| | | system | |
| 2.14 | Last Update Date/ | Generated by | Date (dd-mmm- |
| | Time | system | yyyy) and time |

The Annotation document will be used to record additional information regarding the firm's interpretation of a regulation. The fields for an Annotation document are shown in Table 3.

TABLE 3

| Functional | | | |
|---|---|---|---|
| Require- | | | |
| ment | Field | Constraint | Comment |
| 3.1 | Title | ANNOTATION | |
| 3.2 | Document Status | Generated by | Either “Draft” or |
| | | system | “Current” or “New” |
| 3.3 | Regulation Section | Inherited from the | |
| | | Interpretation | |
| | | document | |
| 3.4 | Regulation Section | Inherited from the | |
| | Code | Interpretation | |
| | | document | |
| 3.5 | Document Title | Required | Manually entered, |
| | | | alphanumeric field |
| 3.6 | Version | Required | Manually entered, |
| | | | numeric field |
| 3.7 | Creation Date | Generated by | Date (dd-mmm- |
| | | system | yyyy) and time |
| 3.8 | Effective Date | Required | Manually entered, |
| | | | date field (dd-mmm- |
| | | | yyyy) |
| 3.9 | Document Author | Generated by | Lotus Notes user ID |
| | | system | |
| 3.10 | Annotation Text | Required | Place the text for |
| | | | this document here. |
| 3.11 | Parent Document | Generated by | The system will |
| | | system | maintain document |
| | | | links to the parent |
| | | | document here. |
| 3.12 | Responses | Generated by | The system will |
| | | system | maintain document |
| | | | links to all child |
| | | | documents here. |
| 3.13 | Last Updated By | Generated by | Lotus Notes user ID |
| | | system | |
| 3.14 | Last Update Date/ | Generated by | Date (dd-mmm- |
| | Time | system | yyyy) and time |

The Best Practices document is used to record any procedural or computer-based technical specifications that relate to the firm's interpretation of a regulation. These Best Practices are used to guide remediation activities. The fields for a Best Practices document are shown in Table 4.

TABLE 4

| Functional | | | |
|---|---|---|---|
| Require- | | | |
| ment | Field | Constraint | Comment |
| 4.1 | Title | FIRM | |
| | | SPECIFICATION | |
| 4.2 | Document Status | Generated by | Either “Draft” or |
| | | system | “Current” or “New” |
| 4.3 | Regulation Section | Inherited from the | |
| | | Interpretation | |
| | | document | |
| 4.4 | Regulation Section | Inherited from the | |
| | Code | Interpretation | |
| | | document | |
| 4.5 | Document Title | Required | Manually entered, |
| | | | alphanumeric field |
| 4.6 | Version | Required | Manually entered, |
| | | | numeric field |
| 4.7 | Creation Date | Generated by | Date (dd-mmm- |
| | | system | yyyy) and time |
| 4.8 | Effective Date | Required | Manually entered, |
| | | | date field (dd-mmm- |
| | | | yyyy) |
| 4.9 | Specification Type | Required | Select either “Tech- |
| | | | nical” or “Pro- |
| | | | cedural”. |
| 4.10 | Document Author | Generated by | Lotus Notes user ID |
| | | system | |
| 4.11 | Best Practices Text | Required | Place the text for |
| | | | this document here. |
| 4.12 | Parent Document | Generated by | The system will |
| | | system | maintain document |
| | | | links to the parent |
| | | | document here. |
| 4.134 | Responses | Generated by | The system will |
| | | system | maintain document |
| | | | links to all child |
| | | | documents here. |
| 4.14 | Last Updated By | Generated by | Lotus Notes user ID |
| | | system | |
| 4.15 | Last Update Date/ | Generated by | Date (dd-mmm- |
| | Time | system | yyyy) and time |

The Architecture document will document any system components (such as, for example, computers, networks, and operating systems) and the interoperability relating to the firm's Best Practices document. The fields for an Architecture document are shown in Table 5.

TABLE 5

| Functional | | | |
|---|---|---|---|
| Require- | | | |
| ment | Field | Constraint | Comment |
| 5.1 | Title | ARCHITEC- | |
| | | TURE | |
| 5.2 | Document Status | Generated by | Either “Draft” or |
| | | system | “Current” or “New” |
| 5.3 | Regulation Section | Inherited from the | |
| | | Specification | |
| | | document | |
| 5.4 | Regulation Section | Inherited from the | |
| | Code | Specification | |
| | | document | |
| 5.5 | Document Title | Required | Manually entered, |
| | | | alphanumeric field |
| 5.6 | Version | Required | Manually entered, |
| | | | numeric field |
| 5.7 | Creation Date | Generated by | Date (dd-mmm- |
| | | system | yyyy) and time |
| 5.8 | Effective Date | Required | Manually entered, |
| | | | date field (dd-mmm- |
| | | | yyyy) |
| 5.9 | Document Author | Generated by | Lotus Notes user ID |
| | | system | |
| 5.10 | Architecture Text | Required | Place the text for |
| | | | this document here. |
| 5.11 | Parent Document | Generated by | The system will |
| | | system | maintain document |
| | | | links to the parent |
| | | | document here. |
| 5.12 | Last Updated By | Generated by | Lotus Notes user ID |
| | | system | |
| 5.13 | Last Update Date/ | Generated by | Date (dd-mmm- |
| | Time | system | yyyy) and time |

The Standard document will document any applicable firm's Standards that apply to the firm's Best Practices document. The fields for a Standard document are shown in Table 6.

TABLE 6

| Functional | | | |
|---|---|---|---|
| Require- | | | |
| ment | Field | Constraint | Comment |
| 6.1 | Title | FIRM STAN- | |
| | | DARD | |
| 6.2 | Document Status | Generated by | Either “Draft” or |
| | | system | “Current” or “New” |
| 6.3 | Regulation Section | Inherited from the | |
| | | Specification | |
| | | document | |
| 6.4 | Regulation Section | Inherited from the | |
| | Code | Specification | |
| | | document | |
| 6.5 | Document Title | Required | Manually entered, |
| | | | alphanumeric field |
| 6.6 | Version | Required | Manually entered, |
| | | | numeric field |
| 6.7 | Creation Date | Generated by | Date (dd-mmm- |
| | | system | yyyy) and time |
| 6.8 | Effective Date | Required | Manually entered, |
| | | | date field (dd-mmm- |
| | | | yyyy) |
| 6.9 | Document Author | Generated by | Lotus Notes user ID |
| | | system | |
| 6.10 | Standard Text | Required | Place the text for |
| | | | this document here. |
| 6.11 | Parent Document | Generated by | The system will |
| | | system | maintain document |
| | | | links to the parent |
| | | | document here. |
| 6.12 | Last Updated By | Generated by | Lotus Notes user ID |
| | | system | |
| 6.13 | Last Update Date/ | Generated by | Date (dd-mmm- |
| | Time | system | yyyy) and time |

The Example document will document approved, and previously implemented, procedural or technical solutions that apply to the firm's Best Practices document. The fields for an Example document are shown in Table 7.

TABLE 7

| Functional | | | |
|---|---|---|---|
| Require- | | | |
| ment | Field | Constraint | Comment |
| 7.1 | Title | EXAMPLE | |
| 7.2 | Document Status | Generated by | Either “Draft” or |
| | | system | “Current” or “New” |
| 7.3 | Regulation Section | Inherited from the | |
| | | Specification | |
| | | document | |
| 7.4 | Regulation Section | Inherited from the | |
| | Code | Specification | |
| | | document | |
| 7.5 | Document Title | Required | Manually entered, |
| | | | alphanumeric field |
| 7.6 | Version | Required | Manually entered, |
| | | | numeric field |
| 7.7 | Creation Date | Generated by | Date (dd-mmm- |
| | | system | yyyy) and time |
| 7.8 | Effective Date | Required | Manually entered, |
| | | | date field (dd-mmm- |
| | | | yyyy) |
| 7.9 | Document Author | Generated by | Lotus Notes user ID |
| | | system | |
| 7.10 | Example Text | Required | Place the text for |
| | | | this document here. |
| 7.11 | Parent Document | Generated by | The system will |
| | | system | maintain document |
| | | | links to the parent |
| | | | document here. |
| 7.12 | Last Updated By | Generated by | Lotus Notes user ID |
| | | system | |
| 7.13 | Last Update Date/ | Generated by | Date (dd-mmm- |
| | Time | system | yyyy) and time |

The Definition document will contain definitions of terms used throughout the system. The fields for a Definition document are shown in Table 8.

TABLE 8

| Functional | | | |
|---|---|---|---|
| Require- | | | |
| ment | Field | Constraint | Comment |
| 8.1 | Title | DEFINITION | |
| 8.2 | Document Status | Generated by | Either “Draft” or |
| | | system | “Current” or “New” |
| 8.3 | Definition Title | Required | Manually entered, |
| | | | alphanumeric field |
| 8.4 | Effective Date | Required | Manually entered, |
| | | | date field (dd-mmm- |
| | | | yyyy) |
| 8.5 | Creation Date | Generated by | Date (dd-mmm- |
| | | system | yyyy) and time |
| 8.6 | Version | Required | Manually entered, |
| | | | numeric field |
| 8.7 | Author | Generated by | Lotus Notes user ID |
| | | system | |
| 8.8 | Description | Required | Place the text for |
| | | | this document here. |
| 8.9 | Last Updated By | Generated by | Lotus Notes user ID |
| | | system | |
| 8.10 | Last Update Date/ | Generated by | Date (dd-mmm- |
| | Time | system | yyyy) and time |

The fields for a Policies, Procedures, and Templates document are shown in Table 9.

TABLE 9

| Functional | | | |
|---|---|---|---|
| Require- | | | |
| ment | Field | Constraint | Comment |
| 9.1 | Title | Required | Policies, Pro- |
| | | | cedures, and Tem- |
| | | | plates” |
| 9.2 | Document Status | Generated by | Either “Draft” or |
| | | system | “Current” or “New” |
| 9.3 | Reference Number | Required | Manually entered, |
| | | | alphanumeric field |
| 9.4 | Policy Title | Required | Manually entered, |
| | | | alphanumeric field |
| 9.5 | Creation Date | Generated by | Date (dd-mmm- |
| | | system | yyy) and time |
| 9.6 | Effective Date | Required | Manually entered, |
| | | | date field |
| 9.7 | Version | Required | Manually entered, |
| | | | numeric field |
| 9.8 | Document Author | Generated by | Lotus Notes user ID |
| | | system | |
| 9.9 | Policy Web Link | Optional | Place any web/URL |
| | | | links here and |
| | | | access via “Execute |
| | | | Link” button. |
| 9.10 | Policy Text | Optional | Place any text, |
| | | | document links, or |
| | | | attachments here. |
| 9.11 | Last Updated By | Generated by | Lotus Notes user ID |
| | | system | |
| 9.12 | Last Update Date/ | Generated by | Date (dd-mmm- |
| | Time | system | yyy) and time |

The Policy Text is contained on the firm's website.

Users of the Inventory Tool component must enter the descriptive information shown in Table 10 for each computer-based system subject to inventory. In Table 10, the term “Text” means alphabetical characters; the expression “Multiple select” means the ability to select one or more items from a table (list) of available choices; the expression “predefined keyword list” means predetermined table (list) of choices; and the term “Flag” indicates a restricted choice that must be made. A Flag may contain more than two choices.

TABLE 10

| | | Required or | |
|---|---|---|---|
| Field Text | Type | Optional | Description |
| Application | Generated | Required | The local representation of |
| Time and Date | by system | | server time and date the |
| Stamp | | | assessment is initiated. |
| System Name | Text | Required | The system name or acronym |
| System Version | Text | Required | The current version number |
| Number | | | of the system/software being |
| | | | inventories |
| System Asset | Text | Required | The asset number(s) or unique |
| Number or | | | identification number(s) for |
| Identifier | | | the system(s) being inven- |
| | | | toried |
| System De- | Text | Required | Text describing the sys- |
| scription | | | tem and the quality records |
| | | | contained |
| System Pur- | Multiple | Required | The type of system being |
| pose | select, | | inventoried. Example: |
| | predefined | | Quality Assurance, |
| | keyword | | Manufacturing Process, |
| | list | | Laboratory |
| Functional Use | Multiple | Required | The locations that the system |
| Location/Site | select, | | is in use and required to be |
| | predefined | | compliant |
| | keyword | | |
| | list | | |
| Breadth of Use | Predefined | Required | The scope of use of the sys- |
| | keyword | | tem. Example: Corporate- |
| | list | | wide, Multiple division, |
| | | | Division, Multi-site, Site, |
| | | | Area |
| In use on or | Flag | Required | Indicates if the system was |
| before | | | in production on or before |
| Sep. 30, 2000 | | | Sep. 30, 2000 |
| Is the system | Flag | Required | Determination if the system |
| developed or | | | was developed by the firm or |
| purchased? | | | purchased from a vendor |
| | | | (includes off the shelf with |
| | | | custom interfaces) |
| Vendor Name | Text | Required* | *Required if previous re- |
| | | | sponse is purchased |
| Platform | Text | Required* | *Required if previous re- |
| | | | sponse is developed |
| Replaces Sys- | Text | Optional | Name of the system being |
| tem Name | | | replaced by the system being |
| | | | inventoried |
| Replaced by | Text | Optional | Name of the system that has |
| System | | | replace the system being |
| | | | inventoried |
| Comment | Text | Optional | |

The information regarding responsibility for assessment, as shown in Table 11, must be entered, as required.

TABLE 11

| | | Required or | |
|---|---|---|---|
| Field Text | Type | Optional | Description |
| Author or System Owner | Selection | Required | Selection to identify the author as the |
| | | | system owner or the system owner's |
| | | | proxy |
| System Owner | Predefined | Required* | Full name of responsible person |
| | by location | | *Not Required for draft Inventory |
| | | | assessment |
| System Owner Division/Site | Predefined | Required | Name (acronym) of firm's division and |
| | by location | | location of firm's site, facility, or entity |
| System Owner Department | Text | Required | Department Name |
| System Owner Manager | Predefined | Required | Name of system owner's manager |
| | by location | | |
| Reference Information | Text | Optional | Text field for any needed references |
| Name of Information System | Text | Optional | Name of the IS or development group |
| (IS) Group | | | responsible for supporting the |
| | | | system/application |
| Name of Information Systems | Text | Optional | Name of an IS or developer with |
| (IS) Contact | | | responsibility for the system |
| | | | development/support |
| Name of Division Senior Staff | Predefined | Optional | Name of senior executive responsible for |
| Member | by location | | the system owner department |

The information with respect to the Author, as shown in Table 12, must be entered, as required.

TABLE 12

| | | Required or | |
|---|---|---|---|
| Field Text | Type | Optional | Description |
| Author | Generated | Required | Full Name of the |
| | by system | | individual creating |
| | | | assessment |
| Author Department | Text | Optional | Author's department |
| | | | name |
| Author Phone | Text | Optional | Author's work telephone |
| | | | number |

The information with respect to routing for signature approval(s), as shown in Table 13, must be entered, as required.

TABLE 13

| | | Required or | |
|---|---|---|---|
| Field Text | Type | Optional | Description |
| Quality Assurance | Predefined | Required | QA individual that is |
| (QA) Representative | by location | | responsible for the |
| | | | records contained on |
| | | | the system |
| First Optional | Predefined | Optional | Other identified |
| Reviewer | by location | | approver |
| Second Optional | Predefined | Optional | Other identified |
| Reviewer | by location | | approver |

The information with respect to quality system determination, as shown in Table 14, must be entered, as required.

TABLE 14

| | | Required or | |
|---|---|---|---|
| Field Text | Type | Optional | Description |
| Is the system a Quality | Choice | Required | Yes or No selection |
| System? | | | |

In order to determine whether or not an electronic record is subject to the regulation, the user must answer a series of questions. A “Yes” response to any of the Quality Assessment questions requires continuing to the question of applicability of the regulation (e.g., 21 CFR, Part 11). A “No” response to all of the Quality System applicability questions allows the screening to end, whereupon the inventory item should be introduced to the review and approval cycle. Questions relating to Quality Assessment are shown in Appendix A.

The information with respect to applicability of the regulation (e.g., 21 CFR, Part 11), as shown in Table 15, must be entered, as required.

TABLE 15

| | | Required or | |
|---|---|---|---|
| Field Text | Type | Optional | Description |
| Does 21 CFR Part 11 apply | Choice | Required | Yes or No selection |
| to this system? | | | |

In order to determine if the regulation (e.g., 21 CFR Part 11) applies to a given computer-based system, the user must answer a system applicability question. A “Yes” response to the applicability question requires continuing to the Priority Indications section. A “No” response to the applicability question allows the assessment to end at this point, whereupon the inventory should be introduced to the review and approval cycle. The information with respect to priority, i.e., relative importance to the operations of the firm, as shown in Table 16, must be entered, as required.

TABLE 16

| | | Required or | |
|---|---|---|---|
| Field Text | Type | Optional | Description |
| System Priority | Choice | Required | Selection of High, Medium, or |
| | | | Low |

In order to establish priorities, the user must select a priority indication (low, medium, high) that is allowable. The author will select the appropriate response for the computer-based system being inventoried. The author will select a single Technical Complexity Indication rating. As an aid in prioritization of corrective actions, the evaluator or analyst must indicate the technical complexity of each computer-based system and each device contained in the inventory. The technical complexity indication can be used to help to prioritize remediation. Table 17 provides for selection of the technical complexity classifications. Table 18 defines the technical complexity classifications.

TABLE 17

| | | Required or | |
|---|---|---|---|
| Field Text | Type | Optional | Description |
| Select Technical | Choice | Required | Selection of High, Medium or |
| Complexity | | | Low |

TABLE 18

| Technical | |
|---|---|
| Complexity | Technical Complexity Description |
| High | A large number of files, large number of fields per file, |
| | databases, interfaces, objects, programs, and or running on |
| | multiple platforms |
| Medium | Multiple files, databases, interfaces, objects, and programs |
| | on a single platform |
| Low | Small number of files, few fields per file, database, |
| | interfaces, objects, and programs on a single platform |

After the technical complexity of a given computer-based system or a given device contained in the inventory has been indicated, that computer-based system or that device, when determined to be in compliance with the regulation, should be submitted for review and approval.

The invention includes a component for evaluating deficiencies between a computer-based system and the requirements of the regulation. This component provides the following major features:

(a) Questions specific to compliance with the regulation and references to specific sections of the regulation and the firm's interpretations of the regulation;

(b) Computational logic that evaluates responses to the questions in feature (a) and provides an indication of the degree of compliance with the regulation; the degree of compliance is based on the percentage of positive answers and the percentage of negative answers;

(c) Indication of technical complexity of the system;

(d) Tracking and assessment of the remedy (optional);

(e) Use of electronic signatures to approve conclusions reached.

In order to assess compliance, the user must respond to specific questions that are relevant to compliance with the regulation. After all such questions have been answered, the evaluation tool will determine whether or not the computer-based system is compliant with the regulation. Computer-based systems determined to be non-compliant are identified as requiring remediation.

Appendix B provides questions relating to the evaluation of deficiencies between the inventoried computer-based system and the requirements of the regulation, as set forth in the interpretations. This evaluation is often referred to as a “gap analysis.” If the evaluator or analyst answers “Yes” to a question, the computer-based system will record the response, and add to a count for the number of interpretations met. If the evaluator or analyst answers “No” to a question, the computer-based system will record the response and add to a count for the number of gaps. A gap is an interpretation that is not met. If the evaluator or analyst answers “N/A” (not applicable) to a question, the computer-based system will record the response and add to the count for number of interpretations met. An “objective evidence or rationale” field is provided for each question. A “Yes” or “N/A” response requires a remark for the objective evidence or rationale field. The total percentage for “Yes” answers and for “No” answers will be displayed at the end of the gap analysis. Computer-based systems having deficiencies, also referred to as gaps, will be indicated as requiring further remediation. Computer-based systems having no deficiencies or gaps indicated (i.e., all answers are “Yes” and “N/A”) are submitted for approval without further evaluation.

Approvals with respect to the appropriateness of conclusions reached or the adequacy of descriptions or references provided are made by means of electronic signatures. Electronic signatures employ a unique user identification and password for the computer-based system. Electronic signatures cannot be excised, copied, or transferred through ordinary means. Electronic signatures cannot be edited, deleted, or falsified through ordinary means. Signature components must be maintained unaltered throughout the retention of the assessments. The computer-based system must be able to readily print and display a complete assessment with signatures associated therewith.

Electronic signatures, i.e., approvals, are required to approve the entries of items in the inventory, i.e., descriptions and screening questions, the evaluation of the system, i.e., answers to evaluation questions and references provided, and tracking of remediation activities, i.e., satisfactory completion of remediation projects. Any user is required to enter his user identification and password for each signature event that rejects or approves an assessment. The computer-based system will authenticate the user identification and password at each event. Valid input will allow the electronic signature event to be completed. Invalid input will not allow the electronic signature event to be completed. User identification and passwords are required for electronic approval signature events. Security logs are used to document unauthorized attempts to obtain access to the system.

For computer-based systems and devices identified as requiring remediation, the author is required to enter the information shown in Table 19.

TABLE 19

| | | Required | |
|---|---|---|---|
| Field Text | Type | or Optional | Description |
| Remediation | Choice | Required | Selection of Active, |
| Project Status | | | Pending or Complete |
| Comment | Free Text | See | Optional while assessment |
| | | description | is in draft. Required when |
| | | | remediation status is |
| | | | indicated as complete. |
| Remediation | Date | Required* | *Required for Active |
| Project Dates | | | status-Planned Start, |
| | | | Planned Completion |
| | | | *Required for Complete |
| | | | status-Planned Start, |
| | | | Planned Completion, |
| | | | Actual Completion. |
| Remediation | Text | Required* | US Dollar— |
| Project Cost | | | *Required for Active |
| (in Thousands) | | | status-Planned Capital |
| | | | Cost, Planned Expense Cost |
| | | | *Required for Complete |
| | | | status-Planned Capital |
| | | | Cost, Planned Expense Cost |
| | | | Actual Capital Cost. |
| | | | Actual Expense Cost |

The computer-based system will allow the Database Manager to modify the document containing the questions relating to the gap analysis (see Appendix B). The questions relating to the gap analysis will be displayed and a status and date will be printed. The status will indicate any changes and deletions made to the questions relating to gap analysis. Previous approved editions of the questions will be maintained. New assessments will use the revised (updated) questions.

System Evaluation assessments in draft form or in form for routing for approval will maintain the current revision until re-assessment. Approved assessment questions are brought forward and correlated to the modified assessment questions upon re-assessment. For example, if the total number of approved assessment questions equals 100 and the total number of modified assessment questions equals 125, the particular number of a given question in the list of approved questions is matched to the particular number of that question in the list of modified questions to which it corresponds.

The computer-based system of this invention preferably contains numerous security safeguards. These security safeguards can be implemented through a user classification structure, wherein roles and responsibilities can be assigned and enforced through programming logic and other security features. The features are described below:

(a) Classifications of users: Users of the system may include Readers, Authors, System Owners, Optional Reviewers, Technical Approvers, Quality Assurance Representatives, Division/Site System Administrators, and Database Manager.

(b) Responsibilities and privileges of users:

(1) Readers: All users having a valid need to access database entries for informational purposes will be granted read-only access to the system (i.e., the reader cannot create, delete, or alter database information). Individuals assigned with Author, System Owner, Optional Reviewer, Technical Approver, Quality Assurance Representative, Division/Site System Administrator and Database Manager responsibilities are granted additional privileges.

(2) Authors have the ability to create and edit database entries and submit them to the assigned System Owner for review and approval.

(3) System Owners accept ownership and responsibility for assigned systems deployed within the firm. They have the ability to edit, review, sign, and approve entries to the database.

(4) Optional Reviewers may be assigned to review entries to the database. They have the ability to review, sign, approve or reject, and return entries to the database.

(5) Technical Representatives review, sign, approve or reject, and return evaluations of the system.

(6) Quality Assurance Representatives review, sign, approve or reject, and return entries to the database.

(7) The Local System Administrator (unique to a specific organizational component of the firm) is responsible for controlling access to the system, maintenance of passwords, and designating individuals as system owners, authors, and quality organization approvers.

(8) Database Manager has the same access as a Local System Administrator for all sites and locations, along with the responsibility for maintaining all reference documents, questions, and user selectable parameters used within the system. The Database Manager is also responsible for assigning Local System Administrators.

The following Appendixes have been described previously. Appendix A shows questions relating to Quality Assessment. Appendix B shows questions relating to the evaluation of deficiencies between the inventoried computer-based system and the requirements of the regulation, as set forth in the interpretations.

Appendix A: Quality System Reference Questions

For help in determining whether or not a system contains “quality and/or regulatory” records, review the following specific questions. Any answers in the affirmative would qualify the record as “quality and/or regulatory”.

Specific Questions

1. Does the software provide statistical analysis for specification setting, sorting, or analysis of clinical or stability data?

2. Does the software provide data or batch records for manufacturing material or component (piece, part, software, firmware, labeling, packing, or assembly) acceptance testing or inspection?

3. Does the software support, control, provide, report, or track information or data related to complaints, clinical trials, or FDA submissions for a finished product or medical device?

4. Does the software support, control, provide, report, or track information or data for preventative maintenance, calibration, or validation of equipment used in manufacturing, design, or development of a finished product or medical device?

5. Does the software support, control, provide, report, or track information or data for validation of software, processes, test methods, equipment, facilities, or utilities used in the production, design, or development of finished goods or medical devices?

6. Does the software support, control, provide, report, or track information or data for the operation or control of equipment used to manufacture finished goods or medical devices?

7. Does the software support, control, provide, report, or track information or data for a product complaint investigation, change request, engineering change notice, commodity change, other type of document or process change, deviation, nonconforming materials report, or any other corrective or preventive actions response?

8. Does the software support, control, provide, report, or track information or data for product complaint investigation efforts?

9. Does the software provide information for a metric or other type of report that will be used in a management review of product performance, quality, distribution, manufacturing, training or complaints?

10. Does the software support, control, provide, report, or track information or data for personnel records required per good manufacturing practices (GMP)?

11. Does the software support, control, provide, report, or track routing information or data for policies, operating procedures, or other quality documentation?

12. Does the software support, control, provide, report, or track information, data, approval, reviews, master documents driving translations, or other outputs related to labeling and/or packaging for product, including clinical and pre-clinical product?

13. Does the software support, control, provide, report, or track information or data for product distribution?

14. Does the software support, control, provide, report, or track information or data for product serial number or product lot number tracking?

15. Does the software support, control, provide, report, or track information or data for shipments, usage, or status of raw materials, commodities, work in process, or finished product?

16. Does the software support, control, provide, report, or track information or data in support of FDA medical device, or medical complaint, or adverse event reporting?

17. Does the software support, control, provide, report, or track information, data, or master documents driving translations for advertising, promotional material, product information, operating manuals, physicians sampling, physicians detailing, or field actions?

18. Does the software support, control, provide, report, or track information or data for audit, quality, or performance trending?

19. Does the software support, control, provide, report, or track information or data for validated environmental control systems?

20. Does the software support, control, provide, report, or track information or data for IQA (incoming quality assurance), development, stability, in-process and finished product laboratory data management?

21. Does the software support, control, provide, report, or track information or data for clinical protocol library files?

22. Does the software support, control, provide, report, or track information or data for medical records, case report files, and source data for clinicals?

23. Does the software provide data verifying compliance with PDMA (Prescription Drug Marketing Act) and Corporate Policy?

24. Does the software support, control, provide, report, or track information essential to perform product recalls?

Device

25. Does the output from this system become part of the design history file, device master record, or device history record?

26. Does the software control or manage records, which support the quality system or are used as part of the design history file, device master file, device history file record?

27. Does the software support, control, provide, report, track routing, or manage change control for design requirements such as design inputs, design outputs, design reviews, design verification, design validation, design transfer, design changes, or any other part of the design history file?

28. Does the software provide information, tracking or access to distribution, installation or servicing of an instrument or software product?

Pharmaceuticals

29. Does the software create, modify, maintain, archive, retrieve, or transmit pharmaceutical R&D regulated activities including GLP drug safety studies, toxicology/pathology, GCP clinical studies, and drug formulation development or evaluation data or records in electronic form?

Drug/Nutritional

30. Does the output from this system become part of the development, clinical, or pre-clinical history file, batch master record, batch history record?

31. Does the software control or manage records, which support a quality system or are used as part of the development, clinical, or pre-clinical history file, batch master record, batch history record? [image] [image] [image] [image] [image] [image] [image] [image] [image] [image] [image] [image] [image] [image] [image] [image] the United States government, with regulations of states, counties, cities, towns, etc., in the United States, with regulations from foreign countries, with regulations promulgated by industrial and business groups, and with any regulation that suggests the use of qualifiers.

Various modifications and alterations of this invention will become apparent to those skilled in the art without departing from the scope and spirit of this invention, and it should be understood that this invention is not to be unduly limited to the illustrative embodiments set forth herein.

What is claimed is:

1. A computer-based system for managing and controlling a firm's program for complying with a regulation put forth by a governmental agency, said system comprising:
(1) an electronic database that documents said regulation and associates said regulation with a firm's interpretations and best practices for compliance with said regulation;
(2) an electronic database that records descriptive information relating to a computer-based system in an inventory and screening criteria to determine if said computer-based system in said inventory is covered by said regulation; and
(3) an electronic database that provides an analytical capability to determine whether said computer-based system in said inventory and covered by said regulation meets criteria of compliance with said regulation.

2. The computer-based system of claim 1, further including means for determining whether corrective action is required to cause said computer-based system in said inventory to meet criteria of compliance with said regulation.

3. The computer-based system of claim 2, further including means to track corrective action undertaken to cause said computer-based system in said inventory to meet criteria of compliance with said regulation.

4. The computer-based system of claim 3, further including means to track costs of said corrective action undertaken to cause said computer-based system in said inventory to meet criteria of compliance with said regulation.

5. The computer-based system of claim 3, further including means to approve said corrective action.

6. A computer-based system for documenting and distributing a regulation of a governmental agency and interpretations, best practices, standards, and examples relating to said regulation, whereby consistency in determining the state of a firm's compliance with said regulation is required by said government agency.

7. A method for managing and controlling a firm's program for complying with a regulation put forth by a governmental agency, said method comprising the steps of:
(a) creating an inventory record, said inventory record comprising a description of a computer-based system and a determination whether said system is covered by said regulation;
(b) submitting said inventory record for approval;
(c) if said inventory record is not approved, correcting said inventory record and repeating step (b);
(d) if said inventory record is approved and said regulation does not apply to said inventory record, terminating said method;
(e) if said inventory record is approved and said regulation applies to said inventory record, providing an evaluation of said system to determine if said system is deficient with respect to said regulation;
(f) submitting said evaluation for approval;
(g) if said evaluation is not approved, correcting said evaluation and repeating step (e); and
(h) if said evaluation is approved and said system is not deficient with respect to said regulation, terminating said method.

8. The method of claim 7, further including the steps of:
(i) if said system is deficient with respect to said regulation, creating a remediation document;
(j) submitting said remediation document for approval;
(k) if said remediation document is not approved, correcting said remediation document and repeating step (j); and
(l) if said remediation document is approved and said system is not deficient with respect to said regulation, terminating said method.

9. The method of claim 7, wherein said system comprises a plurality of computers.
